(19) United States
(12) Patent Application Publication
(10) Pub. No.: US 2011/0115815 A1
(43) Pub. Date: May 19, 2011

(54) Methods and Systems for Image Enhancement

(76) Inventors: Xinyu Xu, Vancouver, WA (US); Scott J. Daly, Kalama, WA (US); Louis Joseph Kerofsky, Camas, WA (US)

(21) Appl. No.: 12/621,452

(22) Filed: Nov. 18, 2009

(51) Int. Cl. G09G 5/00

(52) U.S. Cl. 345/626; 345/204

(57) ABSTRACT

Aspects of the present invention are related to systems and methods for improving content visibility on a liquid crystal display (LCD) under low-contrast viewing conditions. According to one aspect of the present invention an enhanced image may be formed by combining a key-feature map associated with an input image and a brightness-boosted version of the input image.

### FIELD OF THE INVENTION

Embodiments of the present invention relate generally to image enhancement and, in particular, to methods and systems for improving content visibility on a liquid crystal display (LCD) under low-contrast viewing conditions.

### BACKGROUND

Low-contrast viewing conditions may negatively impact, for example, through eyestrain and fatigue, the viewing experience of a user of an LCD device, for example, an LCD television, an LCD mobile device and other devices comprising an LCD display.

Low-contrast viewing conditions may arise when a device is used in an aggressive power-reduction mode, wherein the LCD backlight power level may be dramatically reduced making the image/video content appear dark and less visible to a viewer. The contrast of the image/video may be vastly reduced, or in some cases, pegged at black, and many image features that may convey important scene content may fall below the visible threshold.

Low-contrast viewing conditions may also arise when an LCD display is viewed under high ambient light, for example, direct sunlight. In these situations, the minimum display brightness that a viewer may perceive may be elevated due to the high ambient light in the surroundings. The image/video may appear “washed out” where it is intended to be bright, and the image/video may appear featureless in darker regions.

For both of the above-described low-contrast viewing scenarios, and other low-contrast viewing scenarios, the tonal dynamic range of the image/video may be compressed and the image contrast may be greatly reduced, thereby degrading the viewing experience of the user. Due to increasing consumer concern for reduced energy costs and demand for device mobility, it may be desirable to provide improved digital imagery and video quality to enhance the viewing experience under low-contrast viewing conditions.

### SUMMARY

Some embodiments of the present invention comprise methods and systems for improving content visibility on a liquid crystal display (LCD) under low-contrast viewing conditions.

According to one aspect of the present invention, a key-feature estimator may estimate a key-feature image, also referred to as a key-feature map, associated with an input image, a brightness booster may generate a brightened image associated with the input image and a combiner may combine the key-feature image and the brightened image to form an enhanced image that may exhibit improved content visibility when displayed on an LCD display and viewed under low-contrast viewing conditions. The key-feature image may identify pixels, in the input image, at which there is a large gradient and a well-defined object contour.

According to another aspect of the present invention, the key-feature estimator may estimate the gradient at pixels in a grayscale image associated with the input image using a large-spatial-support gradient calculator.

According to another aspect of the present invention, the brightness booster may determine a boosting factor based on at least one of a power level associated with the LCD display, an ambient-light level associated with the LCD display and a measure of the input-image content.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture depicting an exemplary image under a low back-light-power viewing condition;

FIG. 2 is a picture depicting an exemplary image under a high ambient-light viewing condition;

FIG. 3 is a chart showing exemplary embodiments of the present invention comprising a brightness booster for boosting the brightness level of an input image, a key-feature estimator for estimating a key-feature map associated with the input image and a combiner for combining the brightness-boosted image and the key-feature map;

FIG. 4 is a chart showing exemplary embodiments of the present invention comprising a gradient estimator comprising a large-spatial-support gradient calculator;

FIG. 5 is a picture depicting an exemplary large-spatial support, associated with a pixel location, used in a gradient calculation according to embodiments of the present invention;

FIG. 6 is a picture depicting an exemplary input image;

FIG. 7 is a picture depicting a raw gradient map, determined according to embodiments of the present invention, for the exemplary input image shown in FIG. 6;

FIG. 8 is a picture depicting a gradient map after suppressing low-amplitude gradients, according to embodiments of the present invention, in the raw gradient map shown in FIG. 7;

FIG. 9 is a picture depicting a reversed gradient map generated by polarity reversion, according to embodiments of the present invention, applied to the exemplary gradient map shown in FIG. 8;

FIG. 10 is a picture depicting a contrast-enhanced gradient map, generated according to embodiments of the present invention, associated with the reversed gradient map shown in FIG. 9;

FIG. 11 is a picture depicting the effect of gradient smoothing applied to the exemplary contrast-enhanced gradient map shown in FIG. 10;

FIG. 12 is a chart showing exemplary embodiments of the present invention comprising determining a brightness-boosting factor that maintains the color ratio across three color channels when clipping occurs;

FIG. 13 is a picture depicting a Non-Photorealistic Rendering (NPR) rendition, according to embodiments of the present invention, of the exemplary input image, at full power consumption, shown in FIG. 6;

FIG. 14 is a picture depicting an NPR rendition, according to embodiments of the present invention, of the exemplary input image, at 2% power consumption, shown in FIG. 6;

FIG. 15 is a picture depicting an NPR rendition, according to embodiments of the present invention, of the exemplary input image, viewed in direct sunlight, shown in FIG. 2; and

FIG. 16 is a chart showing exemplary embodiments of the present invention comprising a brightness booster for boosting the brightness level of an input image, a key-feature estimator for estimating a key-feature map associated with the input image, a combiner for combining the brightness-boosted image and the key-feature map and a blending-parameter selector for determining a blending parameter that is used by the combiner.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Low-contrast viewing conditions may negatively impact, for example, through eyestrain and fatigue, the viewing experience of a user of an LCD device, for example, an LCD television, an LCD mobile device and other devices comprising an LCD display.

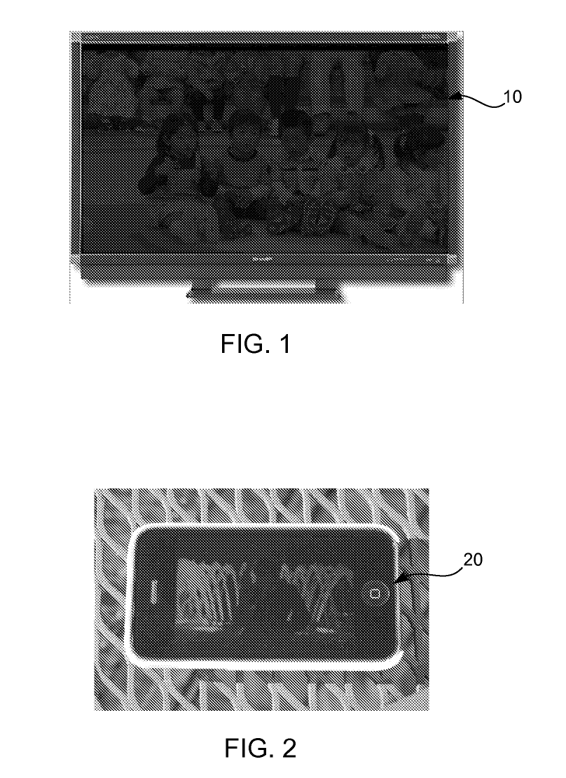

Low-contrast viewing conditions may arise when a device is used in an aggressive power-reduction mode, wherein the LCD backlight power level may be dramatically reduced making the image/video content appear dark and less visible to a viewer. The contrast of the image/video may be vastly reduced, or in some cases, pegged at black, and many image features that may convey important scene content may fall below the visible threshold. FIG. 1 depicts an exemplary image 10 displayed on a device operating under aggressive power-mode reduction.

Low-contrast viewing conditions may also arise when an LCD display is viewed under high ambient light, for example, direct sunlight. In these situations, the minimum display brightness that a viewer may perceive may be elevated due to the high ambient light in the surroundings. The image/video may appear “washed out” where it is intended to be bright, and the image/video may appear featureless in darker regions. FIG. 2 depicts an exemplary image 20 viewed with a mobile phone under high ambient lighting (direct sunlight).

For both of the above-described low-contrast viewing scenarios, and other low-contrast viewing scenarios, the tonal dynamic range of the image/video may be compressed and the image contrast may be greatly reduced, thereby degrading the viewing experience of the user. Due to increasing consumer concern for reduced energy costs and demand for device mobility, it may be desirable to provide improved digital imagery and video quality to enhance the viewing experience under low-contrast viewing conditions.

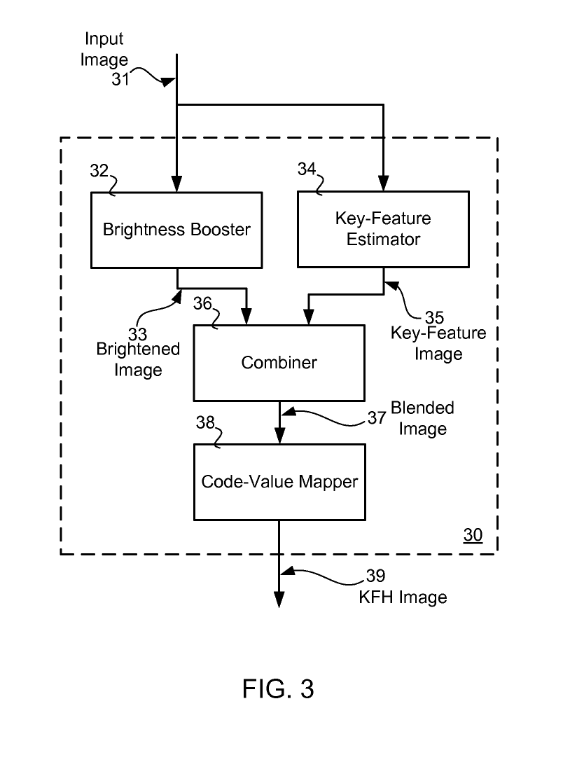

Some embodiments of the present invention described in relation to FIG. 3 may increase the visibility of image/video features in low-contrast viewing conditions by highlighting key image features with Non-Photorealistic Rendering (NPR) techniques. Some of these embodiments may comprise an image-enhancement system 30 comprising a brightness booster 32, a key-feature estimator 34, a combiner 36 and a code-value mapper 38. The image-enhancement system 30 may receive an input image 31 and may make the input image 31 available to the brightness booster 32 and the key-feature estimator 34. In some embodiments of the present invention, the input image 31 may be a color image, for example, an RGB image. In alternative embodiments, the input image 31 may be a gray-scale image. The input image 31 may be a still image or a frame of a video sequence.

The brightness booster 32 may boost the brightness of the input image 31 using a brightness preservation technique, and the brightness booster 32 may generate a brightened image 33 that may be made available to the combiner 36. In some embodiments of the present invention, the brightness booster 32 may boost the brightness of the input image 31 based on information related to an LCD backlight associated with an LCD display on which the enhanced image may be displayed.

The key-feature estimator 34 may estimate a key-feature image 35, also referred to as a key-feature map, from the input image 31 and may make the key-feature image 35 available to the combiner 36.

The combiner 36 may blend the brightened image 33 and the key-feature image 35 to form a blended image 37 which may be made available to the code-value mapper 38. The code-value mapper 38 may form a key-feature-highlighted (KFH) image 39 by mapping the code-values generated by the combiner 36 into code values appropriate for an LCD, for example, to the range of [0,255]. In some embodiments, the KFH image 39 may be made directly available to the LCD for display. The KFH image 39 may also be referred to as an NPR image.

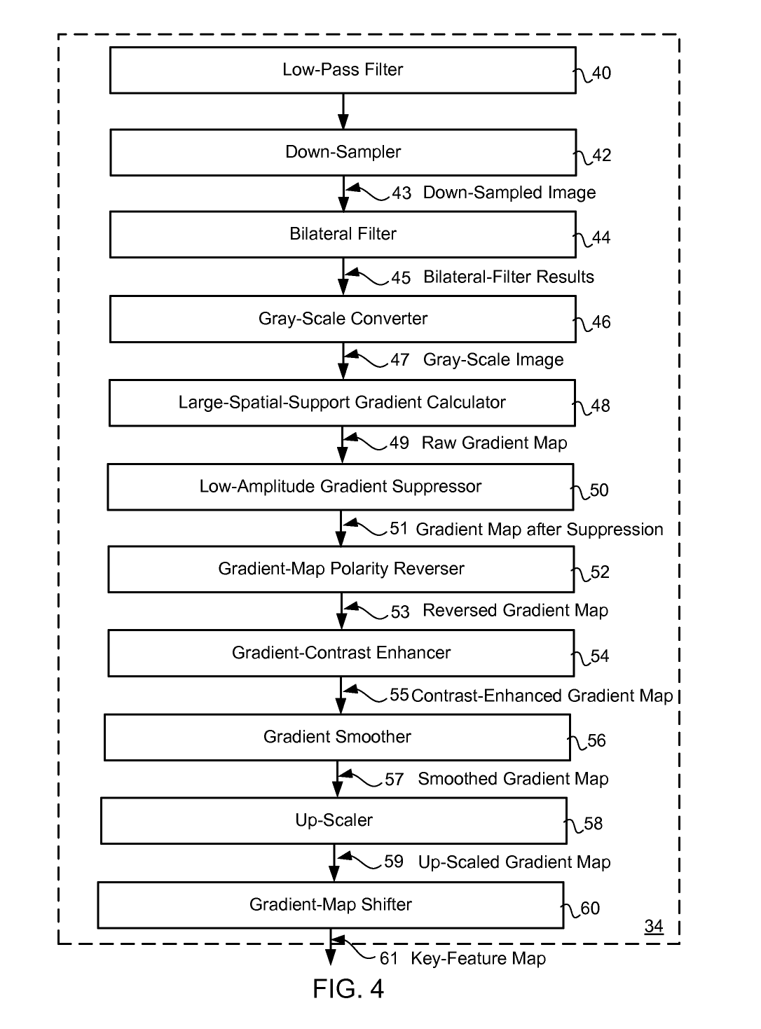

In some embodiments of the present invention described in relation to FIG. 4, the key-feature estimator 34 may comprise a low-pass filter 40 and a down-sampler 42 for reducing, if necessary, the resolution of the input image to a resolution that may allow near real-time processing. Exemplary low-pass filters may include neighborhood pixel-value averaging, Gaussian smoothing, median blur filtering and other low-pass filters known in the art. In some embodiments of the present invention, a low-pass filter may be selected based on computational limitations and/or system resources. Exemplary down-samplers may comprise removal of image rows, removal of image columns, bilinear image resizing, bicubic image resizing, Gaussian pyramid down-samplers and other down-samplers known in the art. In some embodiments of the present invention, a down-sampler may be selected based on computational limitations and/or system resources. In alternative embodiments (not shown), a key-feature estimator may not reduce the resolution of the input image, and may, therefore, not comprise a low-pass filter and a down-sampler.

The down-sampled image 43 may be made available to a bilateral filter 44 which may smooth less-textured areas. Major contours of objects within an image may convey important image information, while less-textured areas may be perceptually less important to a viewer. Thus bilateral filtering may be used to remove unnecessary gradient information, while retaining key edge information corresponding to object contours.

The results 45 of the bilateral filtering may be converted to gray-scale values by a gray-scale converter 46, and gradient estimation may be performed on the gray-scale image 47 by a large-spatial-support gradient calculator 48. Commonly used edge detectors, for example, the Sobel operator, the Canny edge detector and the Laplacian operator, may not effectively detect edges associated with major contours. Use of these common edge detectors may result in broken lines on major object contours. Additionally, minor edges may be detected in less-textured image areas, which may not be desirable in KFH rendering. Further, object boundaries in a gradient map generated using one of the commonly used edge detectors may not be well defined. Embodiments of the present invention may compute image gradients using a large spatial support and may retain, as edge pixels, only pixels with a large gradient value.

In some embodiments of the present invention, the large-spatial-support gradient calculator 48 may comprise a horizontal-gradient calculator and a vertical-gradient calculator. At each pixel in the gray-scale image 47, a horizontal-gradient value may be determined by the horizontal-gradient calculator and a vertical-gradient value may be determined by the vertical-gradient calculator. A gradient value may be assigned to a pixel based on the determined horizontal-gradient value and the determined vertical-gradient value associated with the pixel. In some embodiments, the gradient value assigned to a pixel may be the largest of the horizontal-gradient value and the vertical-gradient value associated with the pixel.

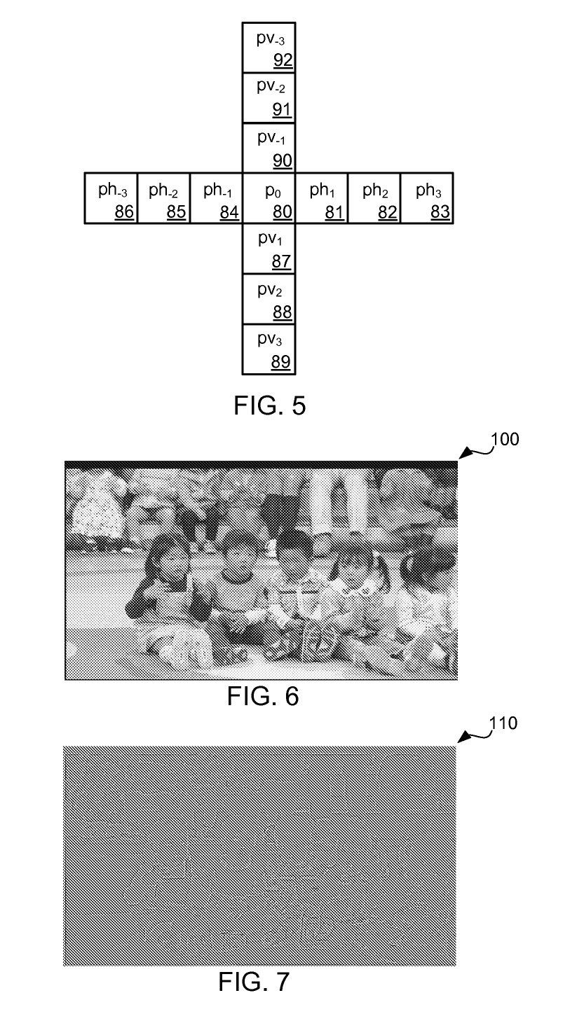

In some embodiments of the present invention, the horizontal-gradient value associated with a pixel may be determined by computing a first-order derivative at the pixel with respect to several horizontal neighbors in each direction, to the left and to the right, of the pixel. The largest derivative value in each direction may be added together to form the horizontal-gradient value associated with the pixel. Similarly, the vertical-gradient value associated with a pixel may be determined by computing a first-order derivative at the pixel with respect to several vertical neighbors in each direction, above and below, the pixel. The largest derivative value in each direction may be added together to form the vertical-gradient value associated with the pixel. In some embodiments of the present invention the size of the one-dimensional search window associated with a direction (left, right, above, below) may be three pixels. FIG. 5 illustrates the large spatial support for an exemplary embodiment in which the one-dimension search window is three pixels. In this example, for a pixel denoted p₀ 80, the horizontal-gradient value, grad_{H}p₀), may be determined according to:

grad_{H}(p₀)=max[D¹(p₀,ph₁),D¹(p₀,ph₂),D¹(p₀,ph₃)]+max[D¹(p₀,ph₋₁),D¹(p₀,ph₋₂),D¹(p₀,ph₋₃)]

and the vertical-gradient value, grad_{V}(p₀), may be determined according to:

grad_{V}(p₀)=max[D¹(p₀,pv₁),D¹(p₀pv₂),D¹(p₀pv₃)]+max[D¹(p₀,pv₋₁),D¹(p₀,pv₋₂),D¹(p₀pv₋₃)]

where D¹(•, •) may denote the first-order derivative and ph₁ 81, ph₂ 82 and ph₃ 83 are the pixels in the one-dimensional search window to the right of the pixel p₀ 80, ph₋₁ 84, ph₋₂ 85 and ph₋₃ 86 are the pixels in the one-dimensional search window to the left of the pixel p₀ 80, pv₁ 87, pv₂ 88 and pv₃ 89 are the pixels in the one-dimensional search window below the pixel p₀ 80 and pv₋₁ 90, pv₋₂ 91 and pv₋₃ 92 are the pixels in the one-dimensional search window above the pixel p₀ 80. The final raw gradient value, grad (p₀), associated with the pixel p₀ 80 may be determined according to:

grad(p₀)=max[grad_{H}(p₀),grad_{V}(p₀)],

thereby producing a raw gradient map 49.

FIG. 6 shows an exemplary image 100, and FIG. 7 shows the resulting raw gradient map 110 determined according to the above-described embodiments of the present invention for the exemplary image 100 shown in FIG. 6. In this example, a three-pixel search window was used.

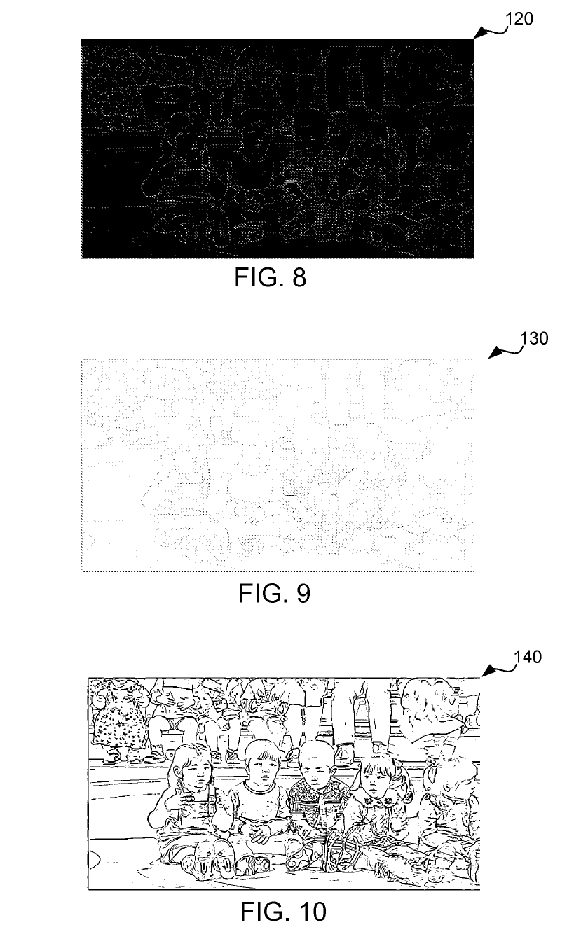

The raw gradient map 49 may contain noisy details. Therefore, the raw gradient map 49 may be made available to a low-amplitude gradient suppressor 50 which may remove low-amplitude gradients. In some embodiments of the present invention, the low-amplitude gradient suppressor 50 may comprise a comparator that compares the gradient amplitude to a threshold according to:

$${grad}_{suppress} ( {p}_{0} ) = \{ \begin{matrix}grad ( {p}_{0} ) , & grad ( {p}_{0} ) > T \\ 0 , & otherwise\end{matrix} ,$$

where T may denote a threshold and gradₛᵤₚₚᵣₑₛₛ (p₀) may denote the low-amplitude-gradient-suppressed gradient map. In some embodiments, the threshold may be set to T=5.0. In alternative embodiments, the low-amplitude gradient suppressor 50 may comprise a zero-crossing detector, and pixel locations associated with zero-crossings may be retained in the gradient map, while non-zero-crossings may be suppressed. FIG. 8 shows the resulting gradient map 120 after suppressing low-amplitude gradients, by thresholding, in the raw gradient map 110 shown in FIG. 7.

The low-amplitude-gradient-suppressed gradient map 51 may be made available to a gradient-map polarity reverser 52 that may reverse the gradient polarity according to:

gradᵣₑᵥ(p₀)=offset−gradₛᵤₚₚᵣₑₛₛ(p₀),

where offset may denote an offset parameter that may be associated with white background and gradᵣₑᵥ(p₀) may denote the reversed gradient map. In some embodiments, the parameter offset may be determined empirically. In some embodiments, offset=120. FIG. 9 shows the outcome 130 of polarity reversion applied to the exemplary gradient map 120 shown in FIG. 8.

The reversed gradient map 53 may be made available to a gradient-contrast enhancer 54 that may improve the contrast of the reversed gradient map 53 and may map the gradient values to the range of 0 to 255. In some embodiments, the gradient-contrast enhancer 54 may map the reversed gradient values according to:

$${grad}_{enhanced} ( {p}_{0} ) = \{ \begin{matrix}255 , & {grad}_{rev} ( {p}_{0} ) = offset \\ 0 , & {grad}_{rev} ( {p}_{0} ) \leq 0 \\ {grad}_{rev} ( {p}_{0} ) + shift , & 0 < {grad}_{rev} ( {p}_{0} ) < offset\end{matrix} ,$$

where shift may denote a contrast shift and grad_{enhanced} (p₀) may denote the contrast-enhanced gradient map. In some embodiments of the present invention, the parameter shift may be determined empirically. In some embodiments, shift=120.

In some embodiments of the present invention, the gradient-contrast enhancer 54 may produce a binary gradient map according to:

$${grad}_{enhanced} ( {p}_{0} ) = \{ \begin{matrix}255 , & {grad}_{rev} ( {p}_{0} ) = offset \\ 0 , & {grad}_{rev} ( {p}_{0} ) < offset\end{matrix} .$$

FIG. 10 shows the outcome 140 of gradient-contrast enhancement applied to the exemplary reversed gradient map 130 shown in FIG. 9.

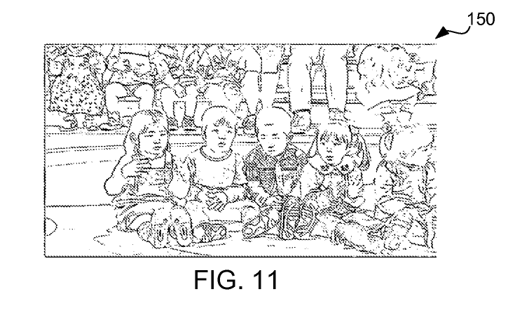

The contrasted-enhanced gradient map 55 may be made available to a gradient smoother 56 that may blur the boundary between foreground edges and white background and may link broken lines. In some embodiments of the present invention, the gradient smoother 56 may comprise a Gaussian low-pass filter. In some embodiments, the kernel size of the Gaussian low-pass filter may be 3×3. FIG. 11 shows the effect 150 of gradient smoothing applied to the exemplary contrast-enhanced gradient map 140 shown in FIG. 10.

The smoothed gradient map 57 may be made available to an up-scaler 58 that may scale the smoothed gradient map 57 to the original input image resolution. The up-scaled gradient map 59 may be made available to a gradient-map shifter 60 that may shift the background of the gradient map to zero. In some embodiments, the gradient-map shifter 60 may subtract 255 from the up-scaled gradient values to shift the background to zero. The resulting key-feature map 61 may be made available from the key-feature estimator 34 to the combiner 36.

In some embodiments of the present invention described in relation to FIG. 3, the brightness booster 32 may boost the brightness of the input image 31 using a linear scaling factor, also referred to as a scaling factor, a boosting factor, a brightening factor and a brightness-boosting factor. In some of these embodiments, the linear scaling factor may be determined such that the brightness is preserved under a predetermined percentage of backlight dimming according to:

$$S = {( \frac{1}{{BL}_{reduced}} )}^{\frac{1}{γ}} ,$$

where S may denote the scaling factor, BL_{reduced} may denote the percentage of backlight dimming and γ may denote the LCD system gamma. In some embodiments, BL_{reduced} may be a predetermined fixed percentage, for example, 15 percent. In alternative embodiments, the scaling factor, S, may be determined adaptively based on image content. In some of these embodiments, the scaling factor, S, may be computed using the color histogram of the input image. As will be appreciated by a person of ordinary skill in the art, the percentage of backlight dimming, BL_{reduced}, may be determined any of the methods and systems known in the art. For example, the percentage of backlight dimming, BL_{reduced}, may be determined according to the methods and systems disclosed in U.S. patent application Ser. No. 11/465,436, entitled “Systems and Methods for Selecting a Display Source Light Illumination Level,” filed Aug. 17, 2006, which is hereby incorporated by reference herein in its entirety.

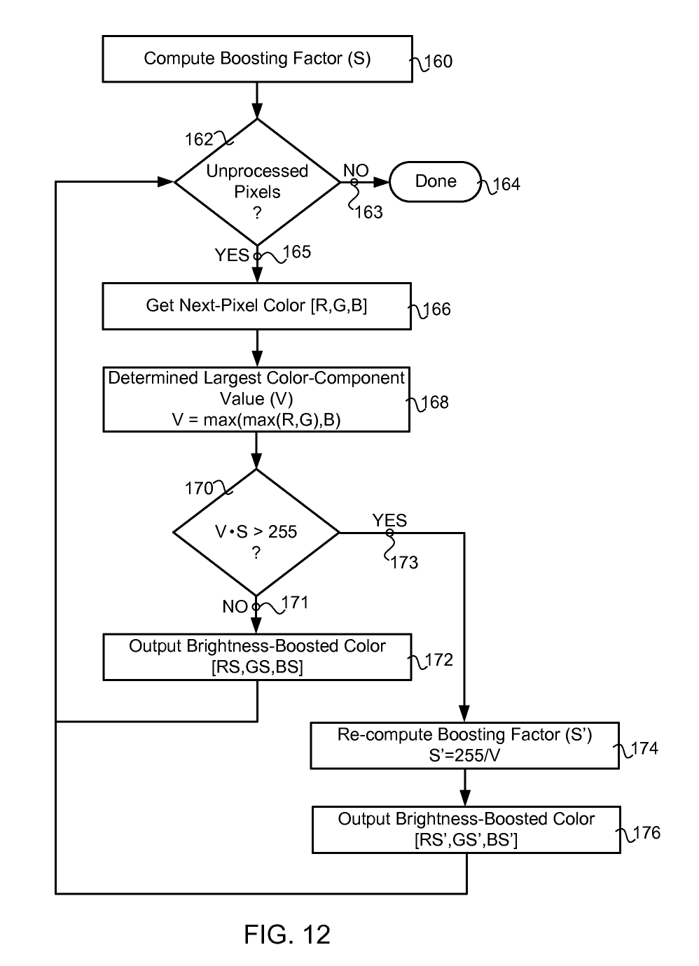

In some embodiments of the present invention, to avoid a clipping problem, the brightness boosting may comprise per-pixel processing described in relation to FIG. 12. The boosting factor, S, may be computed 160, and a determination 162 may be made as to whether or not there are unprocessed pixels. If there are no 163 unprocessed pixels, then the brightness boosting procedure may terminate 164. If there are 165 unprocessed pixels, then the color-component values, denoted [R, G, B] of the next pixel may be obtained 166. The largest color-component value, which may be denoted V, may be determined 168. In some embodiments, V may be determined according to:

V=max(max(R,G),B).

The largest color-component value, V, may be scaled by the boosting factor, S, and the scaled value may be compared 170 to the maximum code value. In some embodiments of the present invention, the maximum code value may be 255. If the scaled value is less than or equal to 171 the maximum code value, the color value associated with the current pixel may be brightness boosted using the scale value, S, and the brightness-boosted color value may be output 172 for the current pixel. A determination 162 may be made as to whether or not there are unprocessed pixels, and the process may continue. If the scaled value is greater than 173 the maximum code value, then the boosting factor may be re-computed according to:

$${S}^{′} = \frac{255}{V} ,$$

where S′ may denote the re-computed boosting factor. The color value associated with the current pixel may be brightness boosted using the re-computed boosting factor, S′, and the brightness-boosted color value may be output 176 for the current pixel. A determination 162 may be made as to whether or not there are unprocessed pixels, and the process may continue. In these embodiments, the color ratio across the three color channels is maintained when clipping occurs, and thus color fidelity is maintained.

In the above-described brightness-boosting methods and systems, a common brightening factor, S, may be used at each pixel, with the exception of pixels for which clipping occurs. In alternative embodiments of the present invention, the brightening factor, S, may be spatially varying according to image content. In some embodiments, the brightening factor, S, may be determined according to:

$$S ( x , y ) = ( α + exp ( - \frac{{f ( x , y )}^{2}}{{σ}^{2}} ) ) , α \geq 1 ,$$

where f(x, y) may be the image brightness at location (x, y), α may be a parameter that controls the range of the brightening factor and σ may be a factor that controls the shape of the Gaussian weighting function. For f(x, y) with a range of [0,255], exemplary parameter values of α and σ are 1.6 and 100, respectively. In these embodiments, the Gaussian weighting function may produce a larger boosting factor, S(x, y), when the brightness f(x, y) is low. Therefore, a pixel with a low-brightness value may be more heavily brightened than a pixel with a larger brightness value.

In alternative embodiments of the present invention, the image brightness values may be quantized into a plurality of brightness-value bins, and a brightening factor may be associated with each brightness-value bin. Pixels with brightness values within the same brightness-value bin may be brightened by the same factor, the brightening factor associated with the respective bin. In some embodiments, the quantization may be based on a histogram of the brightness values.

In some embodiments of the present invention, RGB input values may be converted to an alternative color space, for example, a luminance-chrominance-chrominance color space. Exemplary luminance-chrominance-chrominance color spaces may include YCbCr, YUV, Lab and other luminance-chrominance-chrominance color spaces. In these embodiments, the luminance channel may be brightness boosted while the chrominance channels remain unchanged.

The brightened image 33 generated by the brightness booster 32 and the key-feature image 35 generated by the key-feature estimator 34 may be combined by the combiner 36. In some embodiments of the present invention, the combiner 36 may combine the brightened image 33 and the key-feature image 35 by adding the two images. In alternative embodiments of the present invention, the combiner 36 may blend the images using a weighted average of the two images according to:

I_{KFH}=βI_{boosted}+(1−β)I_{KFM},

where β may denote a blending factor, also referred to as a blending parameter, I_{KFH} may denote the blended image 37, I_{boosted} may denote the brightened image 33 generated by the brightness booster 32 and I_{KFM} may denote the key-feature image 35 generated by the key-feature estimator 34. In some embodiments of the present invention, the blending factor, β, may be a user selected parameter. In alternative embodiments of the present invention, the blending factor, β, may be a predefined value.

The blended image 37 values may be mapped by a code-value mapper 38 to the range of display code values. In some embodiments of the present invention, the range of display code values is [0,255]. In some embodiments, the resulting KFH image 39 may be made available from the image-enhancement system 30 to an LCD display.

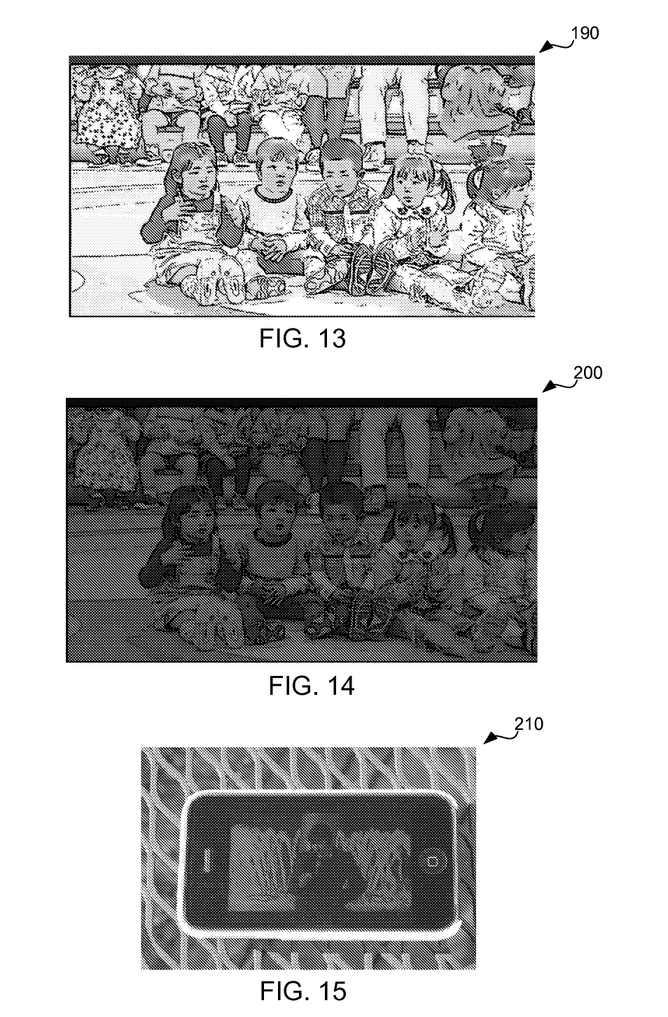

FIG. 13 depicts the NPR rendition 190, according to embodiments of the present invention, of the input image 100, at full power consumption, shown in FIG. 6. FIG. 14 depicts the NPR rendition 200, according to embodiments of the present invention, of the input image 100, at 2% power consumption, shown in FIG. 6. FIG. 15 depicts the NPR rendition 210, according to embodiments of the present invention, of the input image 20, viewed in direct sunlight, shown in FIG. 2.

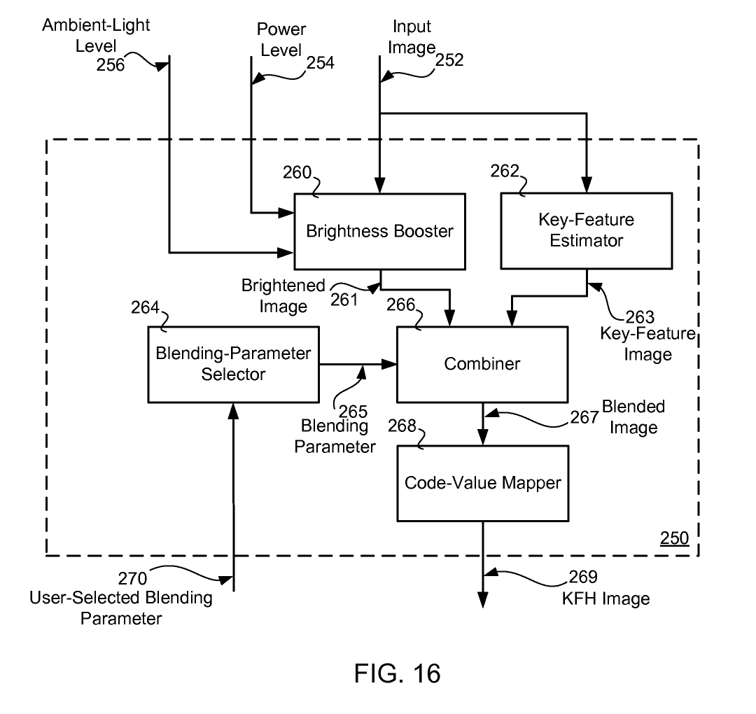

Some embodiments of the present invention, described in relation to FIG. 16, may comprise a brightness booster 260, a key-feature estimator 262, a blending-parameter selector 264, a combiner 266 and a code-value mapper 268. In these embodiments, an input image 252, a backlight power level 254 and an ambient-light level 256 may be received by the image-enhancement system 250. The input image may be a color image or a gray-scale image. The input image 252 may be made available to the brightness booster 260 and the key-feature estimator 262. The backlight power level 254 and the ambient-light level 256 may be made available to the brightness booster 260.

The key-feature estimator 262 may produce a key-feature image 263, also considered a key-feature map, associated with the input image 252. In some embodiments of the present invention, the key-feature estimator 262 may generate the key-feature map 263 according to previously described embodiments of the present invention.

The brightness booster 260 may generate a brightened image 261 based on the input image 252 content, the backlight power level 254 and the ambient-light level 256.

The blending-parameter selector 264 may determine the blending parameter 265 used by the combiner 266 to blend the brightened image 261 and the gradient map 263. A user-selected blending parameter 270 may be provided to the blending-parameter selector 264. In some embodiments of the present invention, the user-selected blending parameter 270 may correspond directly to the blending parameter 265. In alternative embodiments, the user-selected blending parameter 270 may be an image-quality setting selected by a user and associated with a blending parameter 265 value by the blending-parameter selector 264. In some embodiments of the present invention, the blending-parameter selector 264 may select a default value for the blending parameter 265 when a user-selected blending parameter 270 is not available.

The combiner 266 may combine the key-feature image 263 and the brightened image 261 based on the blending parameter 265. In some embodiments of the present invention, the combiner 266 may linearly blend the key-feature image 263 and the brightened image 261 using the blending parameter 265 as a weighting factor according to:

I_{KFH}=βI_{boosted}+(1−β)I_{KFM},

where β may denote the blending parameter 265, I_{KFH} may denote the blended image 267, I_{boosted} may denote the brightened image 261 generated by the brightness booster 260 and I_{KFM} may denote the key-feature image 263 generated by the key-feature estimator 262. In alternative embodiments, the combiner 266 may combine the key-feature image 263 and the brightened image 261 according to:

I_{KFH}=I_{boosted}+I_{KFM}.

The blended image 267 values may be mapped by a code-value mapper 268 to the range of display code values. In some embodiments of the present invention, the range of display code values is [0,255]. In some embodiments, the resulting KFH image 269 may be made available from the image-enhancement system 250 to an LCD display.

Some embodiments of the present invention may comprise an LCD display. Some embodiments of the present invention may comprise an ambient-light sensor.

Some embodiments of the present invention may comprise a computer program product that is a computer-readable storage medium, and/or media, having instructions stored thereon, and/or therein, that may be used to program a computer to perform any of the features presented herein.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A computer-implemented method for enhancing an input image, said method comprising:
a) receiving an input image in a computing device;
b) estimating a key-feature map associated with said input image;
c) forming a brightened image by boosting the brightness of said input image; and
d) combining said key-feature map and said brightened image to form an enhanced image.

2. The method as described in claim 1, wherein said forming is based on at least one of a backlight power level associated with an LCD display, an ambient light level and the image content of said input image.

3. The method as described in claim 1, wherein said forming comprises determining a brightening factor.

4. The method as described in claim 3, wherein said brightening factor is spatially varying.

5. The method as described in claim 1, wherein said forming comprises:
a) determining a first brightening factor;
b) receiving a first color component value associated with a first pixel in said input image;
c) receiving a second color component value associated with said first pixel;
d) receiving a third color component value associated with said first pixel;
e) modifying said first color component value, said second color component value and said third color component value by said first brightening factor when said first-brightening-factor modified first color component value is less than a maximum code value and said first-brightening-factor modified second color component value is less than said maximum code value and said first-brightening-factor modified third color component value is less than said maximum code value; and
f) when said first-brightening-factor modified first color component value is not less than said maximum code value or said first-brightening-factor modified second color component value is not less than said maximum code value or said first-brightening-factor modified third color component value is not less than said maximum code value:
i) determining a second brightening factor based on said maximum code value and the maximum of said first color component value, said second color component value and said third color component value;
ii) modifying said first color component value by said second brightening factor;
iii) modifying said second color component value by said second brightening factor; and
iv) modifying said third color component value by said second brightening factor.

6. The method as described in claim 1 further comprising mapping the pixel values of said enhanced image to code values associated with an LCD display.

7. The method as described in claim 1 further comprising:
a) selecting a blending-parameter value; and
b) using said blending-parameter value in said combining.

8. The method as described in claim 7, wherein said blending-parameter value is used to linearly weight said key-feature map and said brightened image.

9. The method as described in claim 1, wherein said estimating comprises calculating a gradient map from a gray-scale image formed from said input image, wherein said gradient-map calculation is a large-spatial-support calculation.

10. The method as described in claim 1, wherein said estimating comprises:
a) bilateral filtering a low-resolution image associated with said input image;
b) converting said bilateral filtered image to a gray-scale image;
c) performing a large-spatial-support gradient calculation on said gray-scale image, thereby producing a raw gradient map;
d) suppressing low-amplitude gradients in said raw gradient map;
e) reversing the polarity in said low-amplitude-gradient suppressed gradient map;
f) enhancing the gradient contrast in said reversed-polarity gradient map;
g) smoothing the gradient in said gradient-contrast enhanced gradient map; and
h) shifting the background of a gradient map formed from said smoothed gradient map to zero.

11. The method as described in claim 10, wherein said low-resolution image associated with said input image is formed by:
a) low-pass filtering said input image; and
b) down-sampling said low-pass-filtered input image.

12. The method as described in claim 11, wherein said gradient map formed from said smoothed gradient map is formed by up-scaling said smoothed gradient map to the resolution of said input image.

13. The method as described in claim 1, wherein said estimating comprises:
a) determining a first plurality of first-order derivative values in a first horizontal direction in relation to a first pixel location in a gray-scale image associated with said input image;
b) determining a second plurality of first-order derivative values in a second horizontal direction in relation to said first pixel location in said gray-scale image associated with said input image;
c) determining a third plurality of first-order derivative values in a first vertical direction in relation to said first pixel location in said gray-scale image associated with said input image;
d) determining a fourth plurality of first-order derivative values in a second vertical direction in relation to said first pixel location in said gray-scale image associated with said input image;
e) determining a first maximum value, wherein said first maximum value is the maximum value of said first plurality of first-order derivative values;
f) determining a second maximum value, wherein said second maximum value is the maximum value of said second plurality of first-order derivative values;
g) determining a third maximum value, wherein said third maximum value is the maximum value of said third plurality of first-order derivative values;
h) determining a fourth maximum value, wherein said fourth maximum value is the maximum value of said fourth plurality of first-order derivative values;
i) determining a horizontal-gradient value by adding said first maximum value and said second maximum value;
j) determining a vertical-gradient value by adding said third maximum value and said fourth maximum value; and
k) determining a gradient value associated with said pixel location, wherein said gradient value associated with said pixel location is the maximum of said horizontal-gradient value and said vertical-gradient value

14. A system for enhancing an input image, said system comprising:
a) a key-feature estimator for estimating a key-feature map associated with an input image;
b) a brightness booster for forming a brightened image by boosting the brightness of said input image; and
c) a combiner for combining said key-feature map and said brightened image to form an enhanced image.

15. The system as described in claim 14 further comprising a blending-parameter selector for selecting a blending parameter to be used by said combiner.

16. The system as described in claim 14 further comprising a code-value mapper for mapping the pixel values of said enhanced image to code values associated with an LCD display.

17. The system as described in claim 14, wherein said key-feature estimator comprises a gradient-map calculator for calculating a gradient map from a gray-scale image formed from said input image, wherein said gradient-map calculator uses a large-spatial-support in said gradient-map calculation.

18. The system as described in claim 14, wherein said key-feature estimator comprises:
a) a bilateral filter for filtering a low-resolution image associated with said input image;
b) a gray-scale converter for converting said bilateral filtered image to a gray-scale image;
c) a gradient calculator for performing a large-spatial-support gradient calculation on said gray-scale image, thereby producing a raw gradient map;
d) a low-amplitude gradient suppressor for suppressing low-amplitude gradients in said raw gradient map;
e) a gradient-map polarity reverser for reversing the polarity in said low-amplitude-gradient suppressed gradient map;
f) a gradient-contrast enhancer for enhancing the gradient contrast in said reversed-polarity gradient map;
g) a gradient smoother for smoothing the gradient in said gradient-contrast enhanced gradient map; and
h) a gradient-map shifter for shifting the background of a gradient map formed from said smoothed gradient map to zero.

19. The system as described in claim 14, wherein said key-feature calculator comprises:
a) a horizontal-gradient calculator for determining a horizontal gradient at a first pixel location in a gray-scale image associated with said input image, wherein said horizontal-gradient calculator:
i) determines a first plurality of first-order derivative values in a first horizontal direction in relation to said first pixel location;
ii) determines a second plurality of first-order derivative values in a second horizontal direction in relation to said first pixel location;
iii) determines a first maximum value, wherein said first maximum value is the maximum value of said first plurality of first-order derivative values;
iv) determines a second maximum value, wherein said second maximum value is the maximum value of said second plurality of first-order derivative values; and
v) determines a horizontal-gradient value by adding said first maximum value and said second maximum value;
b) a vertical-gradient calculator for determining a vertical gradient at a first pixel location in a gray-scale image associated with said input image, wherein said vertical-gradient calculator:
i) determines a third plurality of first-order derivative values in a first vertical direction in relation to said first pixel location;
ii) determines a fourth plurality of first-order derivative values in a second vertical direction in relation to said first pixel location;
iii) determines a third maximum value, wherein said third maximum value is the maximum value of said third plurality of first-order derivative values;
iv) determines a fourth maximum value, wherein said fourth maximum value is the maximum value of said fourth plurality of first-order derivative values; and
v) determines a vertical-gradient value by adding said third maximum value and said fourth maximum value; and
c) a pixel gradient determiner for determining a gradient value associated with said pixel location, wherein said gradient value associated with said pixel location is the maximum of said horizontal-gradient value and said vertical-gradient value.

20. The system as described in claim 14, wherein said brightness booster uses at least one of a backlight power level associated with an LCD display, an ambient light level and the image content of said input image in forming said brightened image.

21. An image-display system comprising:
a) an input-image receiver for receiving an input image;
b) a key-feature estimator for estimating a key-feature map associated with said input image;
c) a brightness booster for forming a brightened image by boosting the brightness of said input image;
d) a combiner for combining said gradient map and said brightened image to form an enhanced image; and
e) a display for displaying said enhanced image.
